(19) United States
(12) Patent Application Publication
(10) Pub. No.: US 2010/0001781 A1
(43) Pub. Date: Jan. 7, 2010

(54) Reconfigurable Heterodyne Mixer and Configuration Methods

(75) Inventor: Patrice Ulian, Latrape (FR)

Correspondence Address: LARIVIERE, GRUBMAN & PAYNE, LLP, 19 UPPER RAGSDALE DRIVE, SUITE 200, MONTEREY, CA, 93940, US

(73) Assignee: Thales, Neuilly Sur Seine (FR)

(21) Appl. No.: 12/496,526

(22) Filed: Jul. 1, 2009

(30) Foreign Application Priority Data
Jul. 4, 2008 (FR) 08 03813

(51) Int. Cl. H04B 1/26

(52) U.S. Cl. 327/356

(57) ABSTRACT

Heterodyne mixer comprising:
a divider of a signal RF for generating a signal RF1 and a signal RF2;
a reference means comprising a local oscillator generating a reference signal LO;
a second division means for dividing the reference signal into a reference signal LO1 and into a reference signal LO2;
at least two mixture cells mixing on the one hand the signal RF1 with the reference signal LO1 so as to create an intermediate signal IF1 and on the other hand the signal RF2 with the reference signal LO2 so as to create an intermediate signal IF2;
a combiner for recombining the intermediate signal IF1 and the intermediate signal IF2 into an intermediate output signal IF.

The mixer comprises at least one configurable phase-shifting device for phase-shifting a signal via a remote control.

### PRIORITY CLAIM

This application claims priority to French Patent Application Number 08 03813, entitled Reconfigurable Heterodyne Mixer and Configuration Methods, filed on Jul. 4, 2008.

The present invention relates to the field of heterodyne mixers for electromagnetic signals. More particularly, the invention relates to the devices used to reduce the interfering signals at the output of a heterodyne mixer.

Generally, a heterodyne mixer comprises at least one local oscillator, denoted LO, for mixing an input signal, denoted RF, in order to generate a wanted signal at an intermediate frequency, denoted IF.

One known problem among mixers is the generation of numerous mixture products, also called intermodulation products. These interfering signals are the products of the frequencies +/−mRF +/−nLO, with {n, m} being natural integers. Notably, the problem is accentuated when the spectra of the oscillator and/or of the incoming signal are very wide. In the latter case, numerous interfering signals are found in the wanted band or close to the wanted band at the output of the mixer.

One known solution is to eliminate, at the output of the mixer, the interfering mixture products using an appropriate filtering device. This solution presents the advantage of effectively filtering the interfering signals around the wanted signal, but presents the major drawback of not being able to deal with the interfering signals in the wanted band or close to the wanted band.

Another solution consists in choosing heterodyne mixer architectures designed to eliminate certain interfering signals by construction.

Among these architectures, there are simply balanced mixers which result from the association of two simple mixers using dividers and combiners on the RF and/or LO and/or IF ports. The use of such mixers can reduce the number of interfering rays in the wanted band by half.

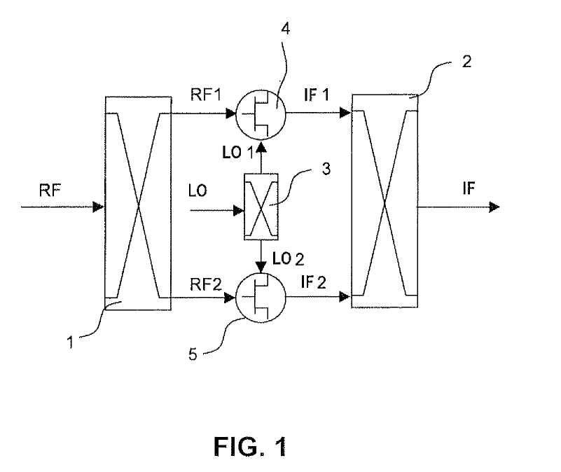

FIG. 1 represents such a simply balanced mixer. The mixer comprises a first divider 1 used to divide an incoming signal RF into two signals RF1 and RF2 that are balanced in amplitude, the phases of RF1 and RF2 possibly being different. A second divider 3 is used to divide the signal LO into two signals LO1, LO2 of the same amplitude and with phases which can be different.

Two mixers 4, 5 respectively mix on the one hand the signal RF1 and the signal LO1 into a first wanted signal IF1 and on the other hand the signal RF2 and the signal LO2 into a second wanted signal IF2.

The signals IF1 and IF2 are of the same amplitude and the same spectrum. They can, on the other hand, include a phase-shift between them according to the phase-shifts of LO1 and LO2 on the one hand and of RF1 and RF2 on the other hand.

A combiner 2 is used to combine the signals IF1 and IF2 into a wanted output signal IF. According to the value of the phase-shift of IF1 and IF2, it is usual to set up a Wilkinson coupler for a phase-shift between IF1 and IF2 of 0°, a Lange coupler (often called “branch-line”) for a phase-shift of 90° and a Marchand coupler for a phase-shift of 180°.

By combination, the principle of such an architecture can be used to reduce certain interfering rays by construction of the signal IF. Certain interfering signals are simply cancelled out by aggregation including a phase-shift for example of 180°.

Other more complex architectures can be used to eliminate a greater number of rays by construction. For example, among these, there are doubly balanced mixers or triply balanced mixers.

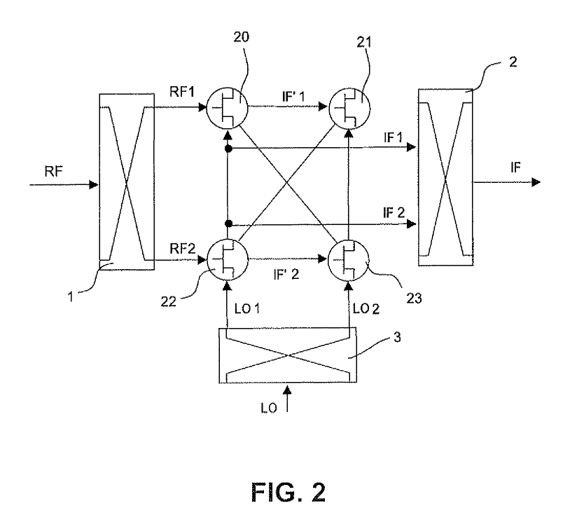

FIG. 2 represents an exemplary architecture of a doubly balanced mixer comprising a divider 1 of the signal RF. The divider 1 is used to obtain two signals RF1 and RF2 that are balanced in amplitude, the phases of which can be different depending on the phase-shift introduced by the divider.

A divider 3 is used, as previously, to divide the signal obtained from the local oscillator in order to obtain two signals LO1, LO2 that are balanced in amplitude. Four mixers 20, 21, 22 and 23 are used to mix the signals RF1, RF2 with the signals LO1 and LO2 in order to obtain the signals IF1 and IF2. The signals IF1, IF2 are then recombined in a combiner 2 in order to obtain an output signal IF.

This solution, more complex than the simply balanced mixer, makes it possible through phase-shifts between the signals LO1 and LO2 and between the signals RF1 and RF2 and finally between the signals IF1 and IF2, to partially eliminate the interfering signals upon combination in the output combiner (2).

This solution presents an advantage of being able to eliminate the interfering signals in the wanted band or close to the wanted band by a simple combination of the signals according to their phase-shift.

On the other hand, this solution presents a major drawback. In practice, the intermodulation products depend on the incoming signal, notably on its frequency and on the wanted band. Consequently, the interfering rays at the frequencies +/−mRF +/−nLO make it essential to choose, from the design phase, appropriate phase-shifts for the dividers and the combiners. Generally, the choice of the phase-shifts in the various divider and combiner elements makes it possible to eliminate the most problematic interfering rays for a given application, that is, for a given incoming signal RF.

One drawback is therefore the absence of flexibility in such an architecture that is constrained to be designed for a specific input signal and notably according to its frequency. The applications of such mixers are therefore more often than not dedicated and do not offer sufficient modularity to adapt to a new input signal or to a new application, except by modifying the components.

Moreover, such a solution is costly in design since it is necessary to develop as many mixers as there are applications.

The invention provides a way of resolving the abovementioned drawbacks.

To this end, the invention makes it possible to have programmable phase-shifters either directly in the dividers and/or in the combiner, or at the input or at the output of the dividers and/or of the combiner of a heterodyne mixer.

This solution makes it possible to adjust the phase-shift between the divided and combined signals from an electrical control according to the type of application used.

Advantageously, the heterodyne mixer comprises:
a first division means (1), balanced in amplitude, of an input signal (RF) for generating a first signal (RF1) and a second signal (RF2);
a second division means (3), balanced in amplitude, for dividing a reference signal (LO) into a first reference signal (LO1) and into a second reference signal (LO2);
at least two mixture cells (4, 5), balanced in amplitude, mixing oil the one hand the first signal (RF1) with the first reference signal (LO1) so as to create a first intermediate signal (IF1) and on the other hand the second signal (RF2) with the second reference signal (LO2) so as to create a second intermediate signal (IF2);
a combining means (2) for recombining the first intermediate signal (IF1) and the second intermediate signal (IF2) into an intermediate output signal (IF).

Advantageously, at least one configurable phase-shifting device can be used to phase-shift a signal by a phase that is adjustable via a remote control, the configurable phase-shifter being positioned in any one of the division or combining means of the mixer, the adjustable phase being chosen so that a set of undesirable mixture products between the divided input signals (RF1, RF2) and the divided reference signals (LO1, LO2) are aggregated in phase opposition in the combining means (2).

Advantageously, two configurable phase-shifters, each being adjusted by means of a remote control, are positioned in each of the division means respectively of the input signal (RF) and of the reference signal (LO).

Advantageously, in another embodiment, two configurable phase-shifters, each being adjusted by means of a remote control, are positioned in each of the division means respectively of the input signal (RF) and of the intermediate signal (IF).

Advantageously, in another embodiment, two configurable phase-shifters, each being adjusted by means of a remote control, are positioned in each of the division means respectively of the reference signal (LO) and of the intermediate signal (IF).

Advantageously, in another embodiment, two configurable phase-shifters, each being adjusted by means of a remote control, are positioned in each of the division means respectively of the input signal (RF), of the reference signal (LO) and of the intermediate signal (IF).

Advantageously, in another embodiment, three configurable phase-shifters, each being adjusted by means of a remote control, are positioned at the output of each of the division means respectively of the signal RF and of the signal IF2 and at the input of the combining means.

Advantageously, the set of the undesirable mixture products are chosen from a set of integers {n, m} that verify the following equation: IF=+/−mRF +/−nLO, where LO is the frequency of the reference signal and RF the frequency of the input signal of the heterodyne mixer.

Advantageously, the remote control drives an electrical control controlling a voltage in N states, N being a positive natural integer.

Advantageously, the adjustable phases of the configurable phase-shifting devices are chosen from the phases 0°, −90°, +90° and −180°.

Advantageously, the adjustable phases of the configurable phase-shifting devices are chosen such that:
+/−nφ_{RF} +/−mφ_{LO} ∈[−180°;+180°], where φ_{RF} is the adjustable phase of the configurable phase-shifting device positioned at one of the outputs of the division means of the input signal and φ_{LO} is the adjustable phase of the configurable phase-shifting device positioned at one of the outputs of the division means of the reference signal.

Advantageously, the method of eliminating a set of intermodulation products interfering with an intermediate signal (IF) obtained from a mixer according to the invention, for applications in which the frequency of the incoming signal (RF) is changed, is characterized in that it comprises:
a first step for calculating the new intermediate frequency (IF);
a second step for calculating the intermodulation products inducing a disturbance on the intermediate signal (IF), consisting in finding the integers n and m such that:
   IF=+/−mRF +/−nLO either in the wanted band or close to the wanted band;
a third step for adjusting, via at least one remote control, at least one adjustable phase of a configurable phase-shifting device of the mixer so as to obtain a set of intermodulation products inducing a disturbance on the intermediate signal (IF) in phase opposition at the input of the combining means.

Advantageously, the first step is to choose an intermediate frequency that verifies an equation:

IF=|±mRF±nLO|

Advantageously, the second step comprises the calculation of the intermodulation products for n and m less than or equal to 5 and for which the amplitude of the products +/−mRF +/−nLO are greater than a predetermined threshold.

Other features and benefits of the invention will become apparent from the following description, given in light of the appended drawings which represent:

FIG. 1: a simply balanced mixer of the prior art;

FIG. 2: a doubly balanced mixer of the prior art;

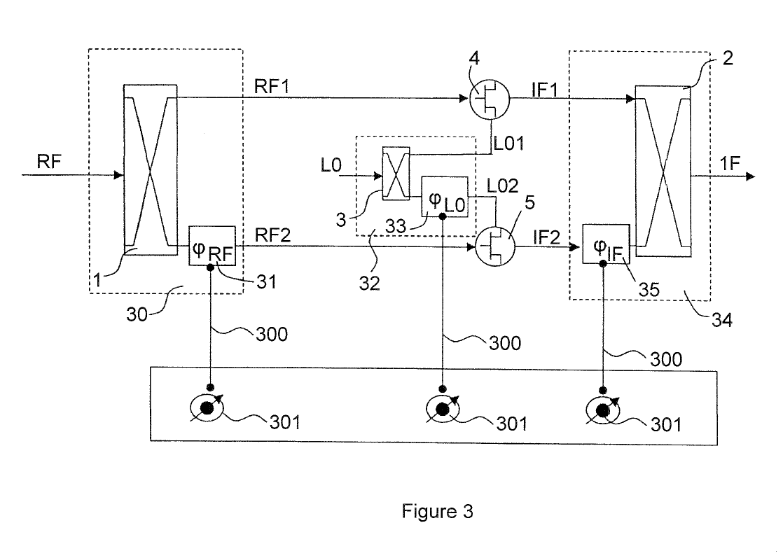

FIG. 3: a simply balanced mixer according to the invention.

Hereinafter in the description, a phase-shifter whose phase is driven by a dynamic, quasi-static or static control signal will be referred to interchangeably as a “programmable phase-shifter” or a “configurable phase-shifter”.

Hereinafter in the description, a dynamic, quasi-static or static control signal will be referred to without distinction as a “remote control”.

The invention makes it possible, in a heterodyne mixer, to modify at least one of the phase-shifts of the combiner and/or of the dividers. An appropriate choice of one of these phase-shifts makes it possible to eliminate a large portion of the intermodulation products introducing disturbances in the wanted band or close to the wanted band at the intermediate frequency. Furthermore, the invention makes it possible to change the phase-shift so that there is no need to modify or replace the components of the heterodyne mixer.

FIG. 3 represents a preferred embodiment of a simply balanced mixer including a divider module 30 comprising a divider 1 and a programmable phase-shifter 31, a divider module 32 comprising a divider 3 and a programmable phase-shifter 33 and finally a combiner module 34 comprising a combiner 2 and a programmable phase-shifter 35.

The incoming signal RF is divided into two signals that are balanced in amplitude, RF1 and RF2, by the divider 1. The signal RF2 can be phase-shifted from the signal RF1 by a phase φ_{RF} that can be adjusted by a remote control 300, 301 driving the programmable phase-shifter 31. The programmable phase-shifter 31 may be located without distinction on the channels RF1 and/or RF2.

FIG. 3 represents respectively three remote controls. Each of the remote controls includes an actuator 301 and a link 300 to the programmable phase-shifter.

The local oscillator LO is divided into two signals LO1 and LO2 balanced in amplitude by the divider 3. The signal LO2 can be phase-shifted from the signal LO1 by a phase φ_{LO} that can be adjusted by a second remote control 300, 301 driving the programmable phase-shifter 33. The programmable phase-shifter 33 can be located without distinction on the channels LO1 and/or LO2.

The signals RF1 and LO1 are mixed by a mixer 4 and the product of the signals generates a wanted signal IF1. Similarly, the signals RF2 and LO2 are mixed by a mixer 5 and the product of the signals generates a wanted signal IF2.

Finally, the signals IF1 and IF2 are combined by the combiner 2. The phase-shifter 35 is used to adjust the phase φ_{IF} of the signal IF2 incoming into the combiner 2. The phase φ_{IF} of the signal IF2 can be adjusted by a remote control 300, 301 driving the programmable phase-shifter. The programmable phase-shifter 35 can be located without distinction on the channels IF1 and/or IF2.

Variant embodiments allow for the use of a single phase-shifter placed in any one of the divider or combiner modules.

Other variants are obtained by using only two programmable phase-shifters in at least two divider and/or combiner modules of a simply balanced mixer.

There are therefore a number of variants, such as those in which a mixer comprises just one programmable phase-shifter. The following three cases are possible:
a programmable phase-shifter in the divider module 30;
a programmable phase-shifter in the divider module 32;
a programmable phase-shifter in the combiner module 34.

Also, heterodyne mixers comprising at least two programmable phase-shifters. The following four cases are possible:
a programmable phase-shifter in the divider module 30 and another in the combiner module 32;
a programmable phase-shifter in the divider module 30 and another in the combiner module 34;
a programmable phase-shifter in the divider module 32 and another in the combiner module 34;
a programmable phase-shifter in each divider module 30 and 32 and another in the combiner module 34;

Generally, in practice, the choice will be made to adjust one or two or three phase-shifts from the three phases φ_{RF,} φ_{IF,} φ_{LO}.

In one embodiment, the phase-shifts of the configurable phase-shifters are preferably chosen between −180°, −90°, 0°, +90°, +180°, but intermediate values are not excluded. This choice of possible phase-shifts makes it possible to calculate the combinations of the phase-shifts of the signals of the two branches of the mixer more effectively.

A preferred embodiment enables the combiner 34 to combine the wanted spectra of the signals IF1 and IF2 in phase and the interfering intermodulation products of the signals IF1 and IF2 in phase opposition. The aggregation in phase opposition of interfering signals of the same frequency and of the same amplitude has the effect of eliminating them from the wanted signal recombined at the output of the combiner.

In an exemplary embodiment comprising the two configurable phase-shifters in one of the branches of the heterodyne mixer, it is possible to adjust two phase-shifts via the remote control. Thus, for a heterodyne mixer comprising a configurable phase-shifter 31 in the divider 1 and a configurable phase-shifter 33 in the divider 3, it is possible to adjust the phase-shifts φ_{RF} and φ_{LO} in one of the branches of the heterodyne mixers.

The phase-shifts φ_{RF} and φ_{LO} are then chosen so as to eliminate the undesirable intermodulation products close to or substantially equal to the frequency of the wanted signal IF.

In theory, there is an infinity of natural integer doublets {m;n} with which to obtain: IF=+/−mRF +/−nLO, in the exemplary embodiment.

In practice, the intermodulation products that interfere with the wanted signal are obtained for low multiples of the frequencies of the signals RF and LO. Generally, the amplitude of the signals becomes higher when the values of n and m are fairly low.

For a signal RF divided into two signals RF1 and RF2 of the same amplitude and the same frequency and a local oscillator LO being divided into two signals LO1 and LO2 of the same amplitude and the same frequency, the mixers generate, in each of the branches of the heterodyne mixer, the same interfering products of signals of type {+/−mRF1 +/−nLO1} and {+/−mRF2 +/−nLO2}, where {n, m} are natural integers.

The wanted products IF1 and IF2 in each branch of the heterodyne mixer are obtained generally by a combination of type RF1−LO1 or RF1+LO1 and RF2−LO2 or RF2+LO2. Nevertheless, it can be another combination chosen to generate a wanted intermediate frequency IF. For example, another case might have been IF=2LO−RF. This depends on the application and on the architecture chosen for the mixer.

The dividers are used to obtain intermediate signals IF1 and IF2 of the same amplitude and of similar spectrum.

The most problematic intermodulation products for processing the signal IF are obtained for values of n and m such that +/−mRF +/−nLO is substantially equal to or very close to the wanted frequency IF.

The phase-shifts φ_{RF} and φ_{LO} introduced from a remote control in one of the branches of the heterodyne mixer make it possible to introduce a phase-shift between the signals IF1 and IF2.

In an exemplary embodiment, the phase-shift Φ=+/−nφ_{RF}+/−mφ_{LO} of the signal IF2 can be adjusted so that it is substantially close to +/−180° for the interfering signals {m;n} in the wanted band or close to the wanted band.

This choice also makes it possible to aggregate in phase opposition in the combiner the undesirable signals previously divided and mixed and having the same frequency and the same amplitude.

In the latter case, a phase-shift Φ introduced in one of the branches of the heterodyne mixer of 180° makes it possible to aggregate disturbing signals in the combiner so that they cancel out.

Generally, the intermodulation products that introduce strong disturbances on the wanted signal are multiples of the signals LO and RF for integer numbers n and m less than 10. It is therefore important to examine the different possible combinations for the different values of m and n such that:
+/−nφ_{RF} +/−mφ_{LO}=+/−180° for the undesirable interfering products {m;n} in the intermediate band IF

Depending on the values of the signals RF and LO, it is possible to choose values of φ_{RF} and φ_{LO} so as to obtain a phase-shift Φ equal to +/−180° for a maximum of interfering intermodulation products.

One benefit of such a solution, when the frequency RF is required to be changed during a mission, lies in the great flexibility of the recalculation of the interfering intermodulation products and of the adjustment of the configurable phase-shifters to adapt the phase-shifts via a remote control.

In an exemplary embodiment of a simply balanced mixer according to the invention, one case can be obtained for the following values:
incoming signal: RF=30 GHz;
local oscillator: LO=10 GHz;
intermediate frequency carrying the wanted signal: IF=20 GHz;

According to the measurements made, three intermodulation products induce significant disturbances in the wanted band:
5LO−RF=20 GHz;
2RF−4LO=20 GHz;
2LO=20 GHz;

For a choice of φ_{RF}=90°, φ_{IF}=0° and φ_{LO}=90°, the elimination of the products 2RF−4LO (2xφ_{RF}−4xφ_{LO}+φ_{IF}=180°) and 2LO (2xφ_{LO}+φ_{IF}=180°) is obtained.

One benefit of such a solution is to be able to adjust the phases φ_{RF,} φ_{IF,} φ_{LO} for different applications needing to process different received signals RF incoming into the mixer. If an application requires the signal RF to be offset in frequency, the phase-shifting of one of the branches of the heterodyne mixer can be adapted from a remote control.

A simple reconfiguration of the phases of at least one programmable phase-shifter can be used to adjust the signals IF1 and IF2 so that the products introducing disturbances can be located in phase opposition in the combiner.

In another embodiment, the phase-shifters can be directly incorporated in the divider or in the combiner, that is, in the component itself.

In variant embodiments, the remote control can be an electrical control controlling a voltage in n states, n being a positive natural integer.

In variant embodiments, the remote control can drive a programmable phase-shifter by a microwave channel. In the latter case, it is possible to reconfigure at least one programmable phase-shifter in embedded applications such as satellites for mission changes.

Finally, a variant embodiment makes it possible to preset, by wiring, to a fixed voltage, the configurable phase-shifters in a doubly balanced mixer in at least one of the dividers or combiner of the mixer such as that represented in FIG. 2.

One benefit of such a solution is to be able to do away by design with complex architectures of heterodyne mixers comprising a wide band handling a mixture product suppression law.

Another benefit is to be able to dynamically reconfigure a mixer that processes a wideband input signal RF with a variable local oscillator. This solution provides a way of eliminating mixture products according to the value of the local oscillator.

1. Heterodyne mixer comprising:
a first division means, balanced in amplitude, of an input signal RF for generating a first signal RF1 and a second signal RF2;
a second division means, balanced in amplitude, for dividing a reference signal LO into a first reference signal LO1 and into a second reference signal LO2;
at least two mixture cells, balanced in amplitude, mixing on the one hand the first signal with the first reference signal so as to create a first intermediate signals IF1 and on the other hand the second signal with the second reference signal so as to create a second intermediate signal IF2;
a combining means for recombining the first intermediate signal and the second intermediate signal into an intermediate output signal IF,
wherein at least two configurable phase-shifting devices are each used to phase-shift a signal respectively by a first and by a second phase that can be adjusted via two remote controls, each configurable phase-shifter being positioned in any one of the division or combining means of the mixer, each adjustable phase being chosen so that a set of undesirable mixture products between the divided input signals and the divided reference signals are aggregated in phase opposition in the combining means.

2. Heterodyne mixer according to claim 1, wherein two configurable phase-shifters, each being adjusted by means of a remote control, are positioned in each of the division means respectively of the input signal and of the reference signal.

3. Heterodyne mixer according to claim 1, wherein a first configurable phase-shifter is positioned in the division means of the input signal and that a second configurable phase-shifter is positioned in the combining means of the intermediate signal.

4. Heterodyne mixer according to claim 1, wherein a first configurable phase-shifter is positioned in the division means of the reference signal and that a second configurable phase-shifter is positioned in the combining means of the intermediate signal.

5. Heterodyne mixer according to claim 1, wherein three configurable phase-shifters, each being adjusted by means of a remote control, are positioned at the output of each of the division means respectively of the signal RF and of the signal IF2 and at the input of the combining means of the signals IF.

6. Heterodyne mixer according to claim 1, wherein the set of undesirable mixture products are chosen from a set of the integers {n, m} that verify the following equation: IF=+/−mRF +/−nLO, where LO is the frequency of the reference signal and RF the frequency of the input signal of the heterodyne mixer.

7. Heterodyne mixer according to claim 1, wherein the remote control drives an electrical control controlling a voltage in N states, N being a positive natural integer.

8. Heterodyne mixer according to claim 1, wherein the adjustable phases of the configurable phase-shifting devices are chosen from the phases 0°, −90°, +90° and −180°.

9. Heterodyne mixer according to claim 6, wherein the adjustable phases of the configurable phase-shifting devices are chosen such that:
+/−nφ_{RF} +/−mφ_{LO}∈ [−180°;+180°], where φ_{RF} is the adjustable phase of the configurable phase-shifting device positioned at one of the outputs of the division means of the input signal and φ_{LO} is the adjustable phase of the configurable phase-shifting device positioned at one of the outputs of the division means of the reference signal.

10. Method of eliminating a set of intermodulation products interfering with an intermediate signal obtained from a mixer according to claim 6, for applications in which the frequency of the incoming signal is changed, wherein it comprises;
a first step for calculating the new intermediate frequency;
a second step for calculating the intermodulation products inducing a disturbance on the intermediate signal, consisting in finding the integers n and m such that:
IF=+/−mRF +/−nLO either in the wanted band or close to the wanted band;
a third step for adjusting, via at least one remote control, at least one adjustable phase of a configurable phase-shifting device of the mixer so as to obtain a set of intermodulation products in phase opposition at the input of the combining means.

11. Method of eliminating a set of intermodulation products interfering with an intermediate signal according to claim 10, wherein the first step is to choose an intermediate frequency that verifies an equation: IF=|±mRF ±nLO|

12. Method of eliminating a set of intermodulation products interfering with an intermediate signal according to claim 10, wherein the second step comprises the calculation of the intermodulation products for which the amplitude of the products +/−mRF +/−nLO are greater than a predetermined threshold.
